(19) United States
(12) Patent Application Publication
(10) Pub. No.: US 2003/0109218 A1
(43) Pub. Date: Jun. 12, 2003

(54) Portable wireless storage unit

(75) Inventors: Ali Pourkeramati, Redwood City, CA (US); Kamran Abadi, Menlo Park, CA (US); Roy Froid, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Azalea Microelectronics Corporation, Santa Clara, CA (US)

(21) Appl. No.: 10/274,517

(22) Filed: Oct. 18, 2002

Related U.S. Application Data
(60) Provisional application No. 60/344,583, filed on Oct. 18, 2001.

(51) Int. Cl. H04H 1/00

(52) U.S. Cl. 455/3.05

(57) ABSTRACT

A portable wireless storage unit for storing data includes a radio-frequency (RF) module, a microprocessor module, a main memory module, and a power control module. The RF module enables wireless communication between the wireless storage unit and a target device, the wireless communication including data transfer requests and data. The microprocessor module processes data transfer requests received by the RF module. The main storage module, which includes a main memory, responds to data transfer requests under control of the microprocessor module by retrieving data from the main memory for transmission by the RF module and by storing data received by the RF module in the main memory. The power control module, which can be coupled to a power source, selectively supplies power to one or more of the RF module, the main storage module, and the microprocessor module.

### CROSS-REFERENCES TO RELATED APPLICATIONS

This application claims the benefit of U.S. Provisional Application No. 60/344,583, filed Oct. 18, 2001, entitled “Portable Wireless Storage Unit,” which disclosure is incorporated herein by reference for all purposes.

### BACKGROUND OF THE INVENTION

The present invention relates in general to data storage devices and in particular to a portable wireless storage device.

Digital data is created and accessed by a variety of electronic devices, including computers, wireless communication devices (e.g., cellular phones), handheld devices (e.g., personal digital assistants, or PDAs), digital cameras, and so on. It is often desirable to transfer or share data between different devices. For instance, after taking a photograph using a digital camera, the photographer may want to transfer the image data to a computer system that provides image editing and printing capabilities. Users who have multiple electronic devices may also want the devices to share information; for instance, such a user may want to share address book information between a cellular phone and a personal digital assistant. Users may also want to transfer data between devices in order to provide a backup in case one device fails.

Existing systems can make data transfer among different devices difficult. For instance, data stored on a PDA can be synchronized with data stored on a desktop computer, but this generally requires connecting a specially designed docking station (e.g., a cradle) to the computer in order to provide a connection to a communication port of the PDA. As another example, digital cameras are often equipped to store image data using removable memory devices (e.g., flash memory sticks). To transfer images stored in the memory device to a computer requires that the computer have a docking station capable of receiving and reading the removable memory device. Most docking stations are designed for a specific device and incompatible with other devices. As a result, a user who has multiple devices that can be docked to a computer often has to have a different docking station for each. If the computer does not have enough I/O ports to connect all of the docking stations at once, the user has to disconnect and reconnect docking stations in order to exchange data with different devices.

Thus, it would be desirable to provide a storage device that is capable of sharing data with a variety of different devices and that does not require a docking station.

### BRIEF SUMMARY OF THE INVENTION

Embodiments of the present invention provides portable wireless storage devices that can communicate via radio frequency (RF) with a variety of electronic devices to provide storage of and access to data. In one embodiment, a portable wireless storage device is capable of communicating with any target device that uses a compatible RF communication protocol, without requiring the target device to have any particular hardware configuration. In some embodiments, a wireless storage device uses a standard RF communication protocol and provides security features such as user or device authentication and data encryption.

According to one embodiment of the present invention, a portable wireless storage unit for storing data includes a radio-frequency (RF) module, a microprocessor module, a main memory module, and a power control module. The RF module enables wireless communication between the wireless storage unit and a target device, the wireless communication including data transfer requests and data. The microprocessor module is coupled to the RF module and configured to process requests received by the RF module. The main storage module, which includes a main memory, is coupled to the microprocessor and configured to respond to data transfer requests under control of the microprocessor module by retrieving data from the main memory for transmission by the RF module and by storing data received by the RF module in the main memory. The power control module is configured to be coupled to a power source and to selectively supply power to one or more of the RF module, the main storage module, and the microprocessor module.

The following detailed description together with the accompanying drawings will provide a better understanding of the nature and advantages of the present invention.

### BRIEF DESCRIPTION OF THE DRAWINGS

FIG. 1 is a high-level block diagram of a portable wireless storage unit according to one embodiment of the present invention;

FIG. 2 is a flow chart illustrating functions performed by a portable wireless storage unit according to one embodiment of the present invention;

FIG. 3 is an intermediate-level block diagram of a portable wireless storage unit according to one embodiment of the present invention; and

FIG. 4 is a flow chart illustrating functions performed by a portable wireless storage unit according to one embodiment of the present invention.

### DETAILED DESCRIPTION OF THE INVENTION

One embodiment of the present invention provides a portable wireless storage unit that can communicate via radio frequency (RF) with a variety of electronic devices to provide storage of and access to data. In one embodiment, a portable wireless storage unit uses a standard communication protocol and is capable of communicating with any remote (target) device that uses a compatible communication protocol, without any particular hardware requirements. The wireless storage unit is advantageously provided with a source of power independent of the target device so that data transfers can be performed without requiring attachment or proximity of the wireless storage unit to the target device.

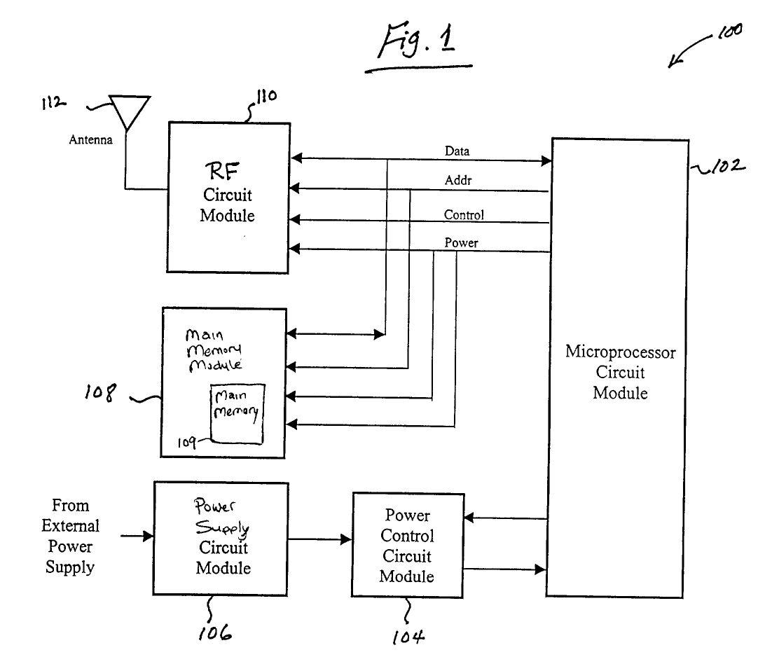

FIG. 1 shows functional components of a portable wireless storage unit 100 in accordance with one embodiment of the present invention. Portable wireless storage unit 100 allows a user to store data received from or download data to various electronic devices, such as desktop or laptop computers, handheld devices, digital cameras, and cellular phones. Storage device 100 includes a microprocessor circuit module 102, a power supply circuit module 106, a power control circuit module 104, a main memory module 108, and an RF circuit module 110. The components communicate via an internal bus that carries address, data, power, and control signals.

Main memory module 108, which includes main memory 109 and additional support circuitry, provides storage for data received by storage unit 100 from remote (target) devices. In one embodiment, semiconductor flash memory is used as main memory 109. Other types of semiconductor memory devices, such as dynamic random access memory (DRAM), static random access memory (SRAM), and ferroelectric-based memory, as well as magnetic media (e.g., hard disk technologies) and optical media may also be used as main memory 109. Non-volatile memory is advantageously used so that a continuous supply of power to main memory 109 is not required.

Microprocessor circuit module 102 contains a microprocessor and support circuitry (e.g., program-code and program-data memory) for controlling the operation of storage unit 100 as described further below.

RF circuit module 110 includes an antenna 112 and support circuitry for transmitting RF signals to and receiving RF signals from one or more target devices. In one embodiment, RF circuit module 110 is configured to use a standard wireless communication protocol, such as Bluetooth or IEEE 802.11a or 802.11b standards, and storage unit 100 can communicate with any electronic device capable of using the selected protocol. In some embodiments, storage unit 100 communicates with more than one electronic device. RF circuit module 110 can be implemented using conventional RF technologies.

Power is provided to storage unit 100 by power supply circuit module 106 and power control circuit module 104. In one embodiment, power supply circuit module 106 includes a rechargeable lithium-ion battery. In another embodiment, power supply circuit module 106 receives power from an external power source (e.g., household AC power via an external or internal DC converter). Power control circuit module 104 selectively supplies power from power supply module 106 to microprocessor circuit module 102, RF circuit module 110, and main memory module 108. Power control circuit module 104 is advantageously configured to minimize power consumption of the various components. In one embodiment, power control circuit module 104 provides power only to those modules (or components within modules) that are required for a given operation. The operation of power control circuit module 104 can be controlled in part by control signals received from microprocessor circuit module 102. Examples of specific power control processes will be described below.

In operation, RF circuit module 110 receives a data transfer request from a remote, or target, device, such as a personal computer, handheld device, or cellular phone. The data transfer request may include, e.g., a request to store new data or transmit stored data. The request is processed by microprocessor circuit module 102, which verifies that the request is valid. If the data transfer request is for storing data, microprocessor circuit module 102 instructs memory module 108 to write data received from the target device via RF circuit module 110. If the data transfer request is for transmitting data, microprocessor circuit module 102 instructs memory module 108 to read the requested data and provide it to RF circuit module 110 for transmission to the target device.

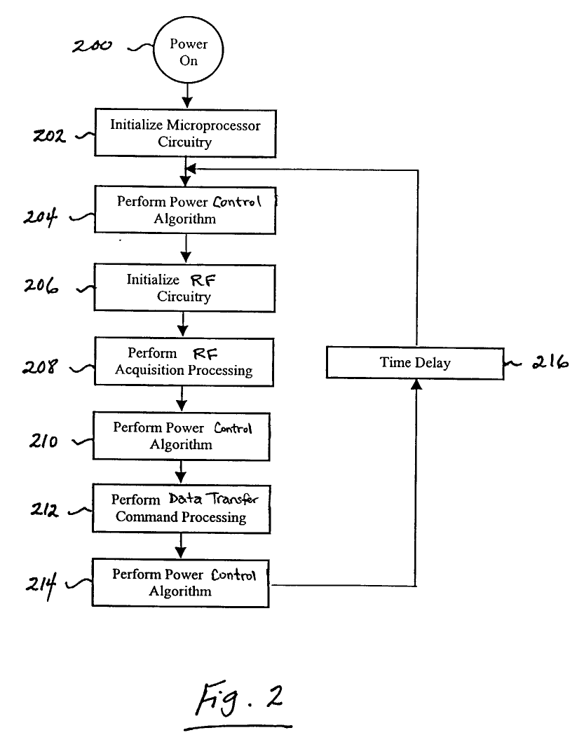

FIG. 2 is a flow chart illustrating functions performed by wireless storage unit 100 in accordance with an embodiment of the present invention. This functionality can be implemented, e.g., in firmware of storage unit 100. At power on (step 200), microprocessor 102 is initialized (step 201). A power control algorithm is executed to initialize power control circuit module 104 and to put other components into a powered-down state (step 204). Subsequently, RF circuit module 110 is powered up and initialized (step 206), and acquisition processing is performed to receive a data transfer request from a target device via RF circuit module 110 (step 208). Acquisition processing can include various actions, such as detecting a signal, verifying the identity of the target device (e.g., through password authentication), and transmitting an acknowledgement message to the target device; such steps can be implemented in accordance with standard communication protocols.

Upon receipt of a data transfer request, another power control algorithm is executed to power up main memory module 108 and enable memory access (step 210). Processor 102 processes the request (step 212), which includes accessing main memory module 108 in order to read or write data. Request processing may also include transmitting or receiving data to or from a target device via RF circuit module 110. After processing the request, another power control algorithm is executed to power down modules which are no longer needed (step 214). In one embodiment, all modules are powered down except for power control circuit module 104. After a predetermined time delay (e.g., one minute) at step 216, during which the device is in a state of minimum power consumption, the process returns to step 204 to receive and process a next data transfer request.

It is to be understood that the storage unit and operations described herein are illustrative, and that variations and modifications are possible. The various modules shown in FIG. 1 are intended only to aid in understanding the invention and are not intended to imply that the modules are implemented as separate physical components, e.g., separate semiconductor dies or chips. The physical dimensions, memory capacity, and RF communication configuration of the wireless storage unit may be varied, and the various functional components can be implemented using hardware (e.g., microprocessors, ASICs, FPGAs), software, firmware, or any combination thereof. For instance, in one embodiment, the storage unit is implemented using one or more integrated circuits, a semiconductor flash memory with a capacity of 4 GB, and a rechargeable lithium-ion battery; such a device can be approximately the size of a credit card in all dimensions for easy portability. Other configurations, shapes, and sizes are also possible.

The operational steps shown in FIG. 2 may be modified or varied. For example, additional power control algorithms may be executed at different stages of operation to further reduce the power consumption of wireless storage unit 100. Alternatively, where low power consumption is less important than other design goals, fewer power control algorithms may be executed. In some embodiments, acquisition processing (step 208) can include a time-out feature, so that if a request is not detected within a certain time interval, the device is powered down and proceeds to step 216. The time delay may be any length desired or omitted entirely, depending on design goals. Further, some of the steps shown sequentially in FIG. 2 may be performed in parallel to improve the performance of wireless storage unit 100.

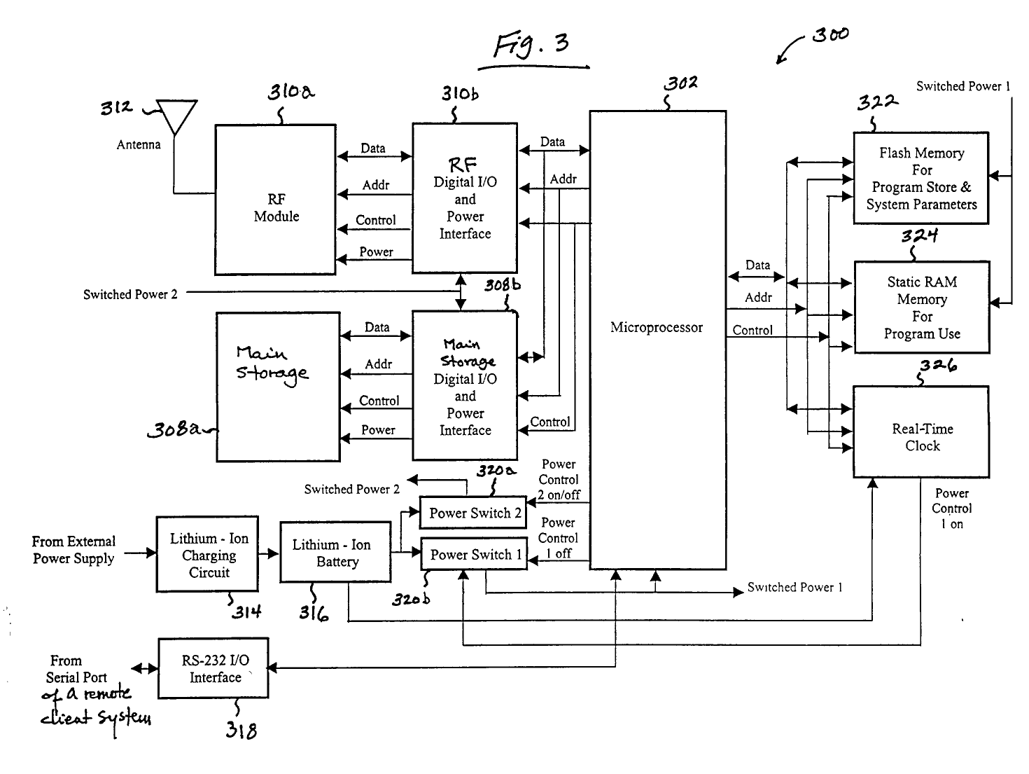

FIG. 3 shows a more detailed block diagram of another embodiment of a wireless storage unit 300 in accordance with the present invention. Wireless storage unit 300 includes a main storage 308a for storing data. In one embodiment, non-volatile semiconductor flash memory with high density and low power consumption characteristics is used as main storage 308a; however, as indicated earlier, the invention is not limited to a particular type of memory.

A main storage interface 308b provides compatible I/O buffering (e.g., CMOS compatible buffering in case of CMOS technology) at an interface between main storage 308a and a microprocessor 302. Main storage interface 308b also implements a memory interface for communicating with main storage 308a (e.g., address decoding, command signaling, and the like). The memory interface advantageously uses standard IDE protocols and commands, but other protocols and commands can be substituted. Power is supplied to main storage interface block 308b under the control of microprocessor 302 via a power switch 320a.

Microprocessor 302, which preferably has low power consumption characteristics, controls the operation of wireless storage unit 300. Microprocessor 302 is connected to main storage interface 308b, a program flash memory 322, a program SRAM (static random access memory) 324, a real time clock 326, an RF interface 310b, and power switches 320a, 320b. In one embodiment, microprocessor 302 is a synchronous device that uses clock signals based on a crystal frequency. The clock frequency can be selected based on the speed and power targets for a particular implementation.

Program flash memory 322 is used primarily for program storage and fixed data storage. In one embodiment, a 64 k byte flash memory is used to store a firmware program to be executed by microprocessor 302, as well as constant data values and system operational parameters needed by microprocessor 302. Flash memory 322 interfaces with microprocessor 302 via an internal bus which includes data, address, and control lines. Real-time clock 326 controls the power to flash memory 322 via power switch 320b. In an alternative embodiment, memory other than flash memory can be used to provide storage for program code, constant data values, and operational parameters; such memory is preferably of a non-volatile type.

Program SRAM 324 is used primarily for storing program variables. In one embodiment, a 32 k byte SRAM is used to store program variables and to provide a data I/O buffer for the RF link. Real-time clock 326 controls the power to program SRAM block 321 via power switch 320b. In an alternative embodiment, memory other than SRAM can be used to provide storage for program variables and data buffering.

Real-time clock 326 is used for system wake-up and data time tagging. More specifically, real-time clock 326 activates power switch 320b at regular intervals to supply power to microprocessor 302, program flash memory 322, and program SRAM 324. Real-time clock 326 can also be used to provide time tag information to the target device. Preferably, power is always supplied to real-time clock 326.

RF module 310a provides the RF capability for wireless memory unit 300. In one embodiment, RF module 310a is based on the Bluetooth standard and is controlled by microprocessor 302 to execute Bluetooth connection and data transfer (i.e., transmitting and/or receiving) protocols. RF interface block 310b provides compatible I/O buffering (e.g., CMOS compatible buffering) at an interface between RF module 310a and microprocessor 302. Power is provided to RF blocks 310a, 310b under the control of microprocessor 302 via power switch 320a.

An antenna 312 is mounted internally to wireless storage unit 300. Antenna 312 may be, for instance, a conventional patch antenna or a quarter-wavelength monopole or dipole antenna. In one embodiment, antenna 312 is physically optimized for the Bluetooth frequency range. Other embodiments may provide an external antenna.

A secondary interface block 318 can be provided to connect wireless storage unit 300 to another device (e.g., a general-purpose computer). Interface block 318 can be implemented according to a serial data transfer protocol (e.g., the RS-232 I/O standard). Interface 318 can be used, e.g., for loading, upgrading, and/or debugging of the firmware stored in program flash memory 322; diagnostic testing of various components of wireless storage unit 310; and related purposes. In one embodiment, interface block 318 can be used for interactive analysis during the firmware development process. Secondary interface block 318 is optional; in some embodiments, firmware management can be provided via the RF communication components.

A lithium-ion rechargeable battery 316 is shown in FIG. 3 as the power source for wireless storage unit 300, although the invention is not limited to any particular power source. It is connected to a charging circuit 314 through which battery 316 may be recharged by an external source. Battery 316 is also connected to power switches 320a, 320b, and real-time clock 326 to ensure that power is supplied to these blocks at all times. Note that wireless storage unit 300 provides the flexibility of being powered either by the internal battery 316 or by a power source external to the unit.

Power switches 320a, 320b are used to control the power consumption of the various components of wireless storage unit 300. Power switch 320b controls power to microprocessor 302, program flash memory block 322, and program SRAM block 324. Real-time clock 326 activates (turns on) power switch 320b from time to time, thereby powering up microprocessor 302, which checks for a data transfer request from any target devices. Subsequently, when operations are completed, microprocessor 302 deactivates (turns off) power switch 320b to place the system into a low power “sleep” mode.

Power switch 320a controls power to RF interface block 310b and main storage interface block 308b. Microprocessor 302 activates and deactivates power switch 320a as needed to minimize power consumption. In some embodiments, power switch 320a is implemented to supply power to different components independently. For instance, power may be supplied to RF blocks 310a, 310b without also supplying power to main storage 308a. One power management scheme primarily aimed at minimizing power consumption will be described below. One skilled in the art with access to the present disclosure will be able to implement other power management schemes.

In some embodiments, storage unit 300 is also equipped with a user-accessible master power switch (not shown) that can be used to disable checking for data transfers, e.g., by preventing real-time clock 326 from activating power switch 320b. This allows the user to disable access to storage unit 300 without physically disconnecting storage unit 300 from its power source.

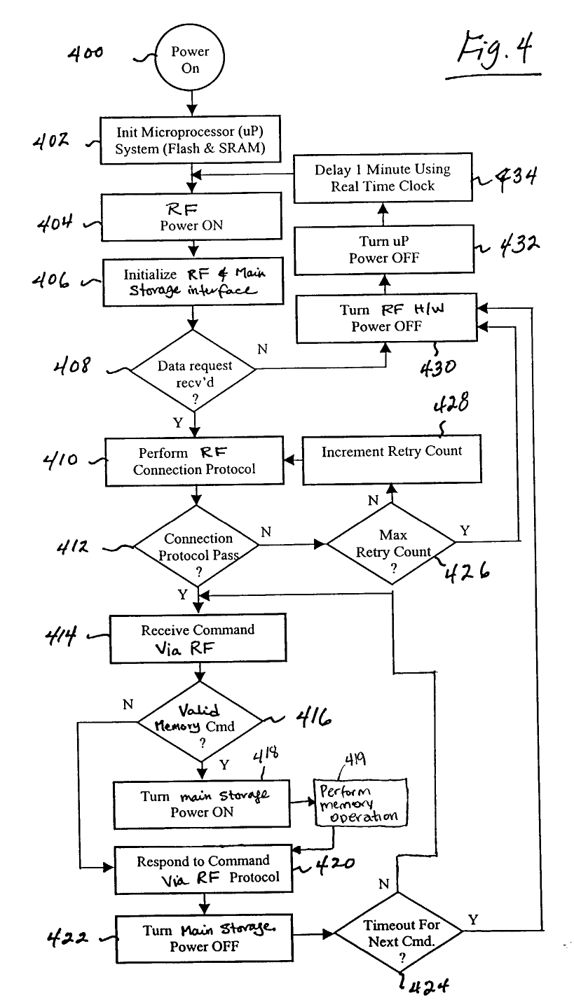

An example of operation of storage unit 300 will now be described with reference to the flow chart shown in FIG. 4. After power on (step 400), microprocessor 302 is initialized via one or more programs maintained in one or both of program flash memory block 322 and program SRAM block 324 (step 402). During initialization, real time clock 326 is set to activate power switch 320b at a predetermined time interval. Next, power is applied to RF blocks 310a, 310b (step 404), and RF blocks 310a, 310b are initialized (step 406).

RF blocks 310a, 310b check for data transfer requests made by any target devices (step 408). If a data transfer request is detected, RF blocks 310, 310b and microprocessor 302 execute connection protocols (step 410) in accordance with the RF standard used (e.g., Bluetooth) to establish a connection. In some embodiments, the connection protocols include authentication of the target device or user (e.g., via a password) and/or data encryption and decryption. Successful execution of the protocols establishes a connection, thereby enabling receipt and processing of data transfer requests. If, at step 412, no connection is established, a retry is performed (steps 426, 428). The storage unit continues to retry until a connection is established or a maximum number of retries is reached (step 426). At that point, the device goes into sleep mode (steps 430, 432, 434) as described further below.

If, at step 412, the connection is established, a request is received and processed by RF blocks 310a, 310b and microprocessor 302 (step 414). At step 416, it is determined whether the request corresponds a valid data transfer operation. If not, main storage 308a is not powered up and an appropriate response (e.g., an “invalid operation” message) is transmitted to the target device (step 420). If the request corresponds to a valid data transfer operation, power is applied to main storage 308a and main storage interface 308b (step 418). At step 419, main storage interface 308b receives the processed command and performs the memory operations associated with the requested data transfer. For example, if the data transfer request is for storing data in wireless storage unit 300, then externally provided data (received via RF blocks 310a, 310b) is transferred to main storage 308a by performing a write operation or an erase-write sequence of operations. Alternatively, if the data transfer request is for retrieving data from wireless storage unit 300, a read operation from main storage 308a is performed.

At step 420, a response is transmitted to the target device via RF blocks 310a, 310b. The response depends on the specific data transfer request. For example, if the request was for storing data, an acknowledgement or “done” message may be transmitted to the target device in accordance with the communication protocol. If the request was for retrieving data, the response includes the requested data. Data transmissions are formatted according to the communication protocol, and data may be encrypted and/or compressed by microprocessor 302 prior to transmission.

Once the data transfer to or from main storage 308a is complete, main storage 308a and main storage interface 308b are powered down (step 422). Next, a timeout period is provided, during which storage unit 300 attempts to detect another request from the target device (step 424). If another request is detected before the timeout period expires, the process returns to step 414 to process the new request. If another request is not detected during the timeout period, power switches 320a, 320b are disabled to power down RF blocks 310a, 310b, program flash memory block 322, program SRAM block 324, and microprocessor 302 (steps 430, 432). Next, a short “sleep” period (e.g., one minute) is allowed to elapse (step 434), at the end of which real-time clock 326 activates power switch 320a to power up microprocessor 302. Microprocessor 302 then powers on RF blocks 310a, 310b again (step 404) to allow storage unit 300 to detect whether another request is being sent by a target device.

It is to be understood that the wireless storage unit described herein is illustrative and that device components and operations may be modified or varied. The functional blocks shown in FIG. 3 reflect operational features of one embodiment of a wireless storage unit in accordance with the invention. The different blocks are not intended to represent separate physical components, such as semiconductor dies or chips. In fact, performance and space efficiency can be maximized by having functions described as being performed by different blocks implemented on the same monolithic semiconductor (e.g., one die). Communication protocols, timeout and sleep periods, and sequences of power-up and power-down operations described herein may be altered as desired. The sleep period can be any length and may be omitted entirely, e.g., where a fast response time is required. The memory access operations can be defined as desired, e.g., according to a standard IDE (integrated drive electronics) protocol.

In addition, requests other than data transfer requests can be recognized and processed. For instance, in some embodiments, storage unit 300 includes security features to prevent unauthorized access to data, such as password authentication and/or data encryption. A target device may transmit requests related to creating, changing, or deleting passwords and/or encryption keys, and storage unit 300 may receive and process such requests. It will be appreciated that passwords, encryption keys, and the like are advantageously stored in program flash memory 322 so that requests related to such features can be processed without powering up main storage 308a.

It will be apparent from the foregoing description that wireless storage device 300 is capable of communicating with any RF-enabled target device that uses the appropriate communication protocols and data transfer commands. Such functionality can be implemented in target devices in a variety of ways for different applications of the wireless storage unit of the present invention. Some examples will now be described.

In one application, a driver for interacting with the wireless storage unit resides on a target device that requires remote data storage. The driver is typically implemented in software and/or hardware installable in the target device and adapted to the particular requirements of the target device. For instance, a wireless storage driver for a PDA that is sold without RF communication capacity would typically include an RF hardware component, while a wireless storage driver for a cellular phone would typically be adapted to use the RF circuitry already present in the cellular phone.

The driver device executes any RF protocols (e.g., Bluetooth protocols) required by the wireless storage unit, and performs the target-side processing related to any password authentication and data encryption/decryption protocols that may be implemented. The driver also transmits the data transfer commands in a format recognized by the wireless storage unit (e.g., IDE commands). In some instances, the driver device also presents a “virtual disk drive” interface to the user, allowing the user to interact with the wireless storage unit in essentially the same manner as a locally mounted disk. In one embodiment, an Application Programming Interface specification for a virtual disk drive application may be provided. This specification includes a detailed definition of the main-storage access commands recognized by the wireless storage unit (e.g., IDE commands such as file data read, file data write, file directory, and the like).

In another application, a wireless storage unit utility program resides on a target device that requires remote data storage. The utility program can be packaged with the driver or separately as desired. The utility program performs various functions, including interfacing to the wireless storage unit driver device for data I/O; maintenance of passwords and encryption/decryption keys (e.g., creating, deleting, and changing passwords or keys); and setting up operation parameters for one or more target devices and one or more wireless storage units that communicate with each other. An Application Programming Interface specification for the wireless storage utility program can also be used. This specification includes a detailed definition of the utility software commands (password operations, data encryption operations, and parameter modifications) that may be communicated to or from the wireless storage unit.

In one embodiment, “C++” language is used for the driver software, and Microsoft's “C++” software tools are used to develop and debug the driver. Other languages and tools can also be used.

It is to be noted that the portable wireless storage unit advantageously has access to a source of power independent of the remote device (e.g., a battery or household AC), so that no physical connection or close proximity between the storage unit and the target device is required for operation of the storage unit. The distance between the storage unit and the target device is limited only by the characteristics of the RF technology of a particular implementation, which is a matter of design choice.

While the invention has been described with respect to exemplary embodiments, one skilled in the art will recognize that numerous modifications are possible. A portable wireless storage unit can be implemented with more or fewer or different components than the embodiments described herein, and the operational steps can be adapted to the requirements of a specific implementation. It will also be appreciated that a single wireless storage unit can be implemented to communicate with any number or combination of target devices, as long as each target device has an appropriately configured driver device. In addition, a target device can be adapted to communicate with multiple wireless storage units. Existing communication protocols that support multi-device communication can be used in such embodiments.

Thus, although the invention has been described with respect to exemplary embodiments, it will be appreciated that the invention is intended to cover all modifications and equivalents within the scope of the following claims.

What is claimed is:

1. A portable wireless storage unit for storing data, comprising:
a radio-frequency (RF) module configured to enable wireless communication between the wireless storage unit and a target device, the wireless communication including data transfer requests and data;
a microprocessor module coupled to the RF module and configured to process data transfer requests received by the RF module;
a main storage module including a main memory, the main storage module coupled to the microprocessor and configured to respond to data transfer requests under control of the microprocessor module by retrieving data from the main memory for transmission by the RF module and by storing data received by the RF module in the main memory; and
a power control module configured to be coupled to a power source and to selectively supply power to one or more of the RF module, the main storage module, and the microprocessor module.

2. The storage unit of claim 1, wherein the power control module selectively supplies power at least in part in response to commands received from the microprocessor module.

3. The storage unit of claim 2 wherein the power control module supplies power to the main storage module during a memory access operation and powers down the main storage module after the memory access operation is completed.

4. The storage unit of claim 1, wherein the power control module includes:
a first power switch unit configured to selectively provide power to the microprocessor module; and
a second power switch unit configured to selectively provide power to the RF module and the main storage module.

5. The storage unit of claim 4, further comprising:
a clock module configured to periodically activate the first power switch unit, thereby causing power to be provided to the microprocessor module.

6. The storage unit of claim 4, wherein the second power switch unit is controlled by the microprocessor.

7. The storage unit of claim 1, wherein the main memory includes a semiconductor flash memory.

8. The storage unit of claim 1, further comprising an internal power source coupled to the power control module.

9. The storage unit of claim 8, wherein the internal power source includes a lithium-ion battery.

10. The storage unit of claim 1, wherein the RF module implements a standard protocol for wireless communication.

11. The storage unit of claim 10, wherein the standard protocol is a Bluetooth protocol.

12. The storage unit of claim 1, wherein the microprocessor module includes an auxiliary memory configured to store program code to be executed by the microprocessor module and program data to be used in executing the program code.

13. The storage unit of claim 12, further comprising:
a secondary interface configured to connect the storage unit to a host device, wherein the host device accesses the auxiliary memory via the secondary interface.

14. The storage unit of claim 13, wherein the secondary interface includes a serial data communication interface.

15. A data storage system, comprising:
a portable wireless storage unit, including:
a radio-frequency (RF) module configured to enable wireless communication between the wireless storage unit and a target device, the wireless communication including data transfer requests and data;
a microprocessor module coupled to the RF module and configured to process data transfer requests received by the RF module;
a main storage module including a main memory, the main storage module coupled to the microprocessor and configured to respond to data transfer requests under control of the microprocessor module by retrieving data from the main memory for transmission by the RF module and by storing data received by the RF module in the main memory; and
a power control module configured to be coupled to a power source and to selectively supply power to one or more of the RF module, the main storage module, and the microprocessor module; and
a wireless storage driver adapted to be used by a target device, the wireless storage driver configured to communicate with the portable wireless storage device.

16. The data storage system of claim 15, wherein the wireless storage driver is further configured to provide a virtual disk drive interface to the portable wireless storage unit.

17. The data storage system of claim 15, wherein the wireless storage driver is further configured to communicate security information to the portable wireless storage unit.

18. The data storage system of claim 17, wherein the security information includes encryption key information.
